(19) United States
(12) Patent Application Publication
(10) Pub. No.: US 2003/0106944 A1
(43) Pub. Date: Jun. 12, 2003

(54) Gas barbecue fire suppression device

(76) Inventor: Jerald Doppelt, North Caldwell, NJ (US)

Correspondence Address: BRUCE E. LILLING, LILLING & LILLING P.C., P.O. BOX 560, GOLDEN BRIDGE, NY, 10526, US

(21) Appl. No.: 10/015,491

(22) Filed: Dec. 12, 2001

(51) Int. Cl. B05B 12/08; B05B 17/04; A62C 2/00; F24C 3/12

(52) U.S. Cl. 239/65; 169/65; 126/42

(57) ABSTRACT

The fire suppression device is based on installing a cannister of a fire extinguishing composition on a gas barbecue. Tubes from the cannister direct the fire extinguishing foam or composition to flames that may shoot out from the Venturi tubes or the burners or the cooking surface.

### FIELD OF THE INVENTION

The invention pertains to the outdoor and recreational industries and, in particular, to safety devices for gas barbecues.

### BACKGROUND OF THE INVENTION

One of the most popular cooking modes for outdoor and recreational cooking and eating is to use a barbecue. Traditionally, this involved charcoal or wood as the source of flame.

In recent decades, the use of propane gas or natural gas has become more common. Many homes include outdoor gas connections for use with a barbecue. When such connections are not available, a propane tank is used.

Whether used with a gas line or a propane tank, the barbecue itself is constructed in the same manner. Venturi tubes direct the gas to the burner(s). Over time, these tubes may become clogged or damaged. Insects, spiders, food droppings and other small objects can block or partially block the Venturi tubes. Rain, heat, snow, wind and weather in general can all cause the tubes to wear and deteriorate over time.

When the Venturi tubes are blocked or worn, there can be a tendency for the flow of gas to be impeded or redirected. This can cause a flame up and the gas will be ignited and fire will extend out from the Venturi tubes. This can be dangerous for various reasons. First, if prolonged, it could ignite the propane tank. Burn injuries can be suffered by people close to the barbecue. It may also cause the food on the barbecue to be burnt and ruined. If not extinguished, the fire could also spread and cause considerable collateral damage.

Once the gas grill is ignited, a blockage or wearing of the Venturi tubes will cause the fire to shoot back out through openings in the Venturi tubes via the control panel of the barbecue, the underside or the left and/or right sides of the grill. This shooting back of the fire directly exposes the user and the propane tank (or gas source) to the hazardous flames. Though the flames may be in the way, the user must either try to turn the control knobs to the off position or quickly disconnect or turn off the gas source.

On May 24, 1996, the U.S. Consumer Product Safety Commission through its Office of Information and Public Affairs issued News Release #96-132. It warned that “Each year, about 40 people are injured in LP fires and explosions associated with gas grills.” In 1995, the U.S. Consumer Product Safety Commission requested voluntary standards for gas grills to eliminate leak hazards, e.g. a device to limit the flow of gas in the event of hose rupture, a mechanism to shut-off the grill, and a feature to prevent the flow of gas if the connection between the tank and the grill is not leak proof.

Notwithstanding the U.S. Consumer Product Safety Commission recommendations, there is still no built-in device to put out fires once they start. Instead, external fire extinguishers need to be used. Generally, the problem is exacerbated, because the flame prevents people from reaching under the barbecue to close the propane tank, so the flow of additional gas into the fire is hard to stop. Since the flow of gas cannot be stopped, the fire grows larger and can become dangerous.

The U.S. Consumer Product Safety Commission issued Fact Sheet Publication #467 for Gas Grills. There is an emphasis on the fact that “By following these guidelines, you'll help prevent possible gas explosions or fire.” Here again, one can see the concern about fires. Despite the concern for fire, there are still only guidelines for preventing fires, and no instructions as to how to put out a fire.

While the U.S. Consumer Product Safety Commission and the Industry itself recognize the dangers of fire in gas grills and even provide suggestions and devices to avoid fires, there is still no built-in or attached device to extinguish fires. Thus, there is a critical shortcoming and no immediate simple vehicle to extinguish or control the fires.

### SUMMARY OF THE INVENTION

Therefore, it is an object of the invention to address the possible fire related dangers of gas grills, as recognized by The U.S. Consumer Product Safety Commission.

A principal object is to provide a built-in or attached device and/or system that will extinguish fires before they become large and cause damage.

These and other objects are accomplished by inclusion of a fire extinguishing cannister on the barbecue unit. A metal tube extends from the cannister to the area under the Venturi tubes. When a flame impermissibly shoots out from the Venturi tubes, the user activates the cannister to eject a flame extinguishing foam or composition that flows through the metal tube and covers and extinguishes the fire.

Necessarily, the cannister must be mounted far enough away from the Venturi tubes and the burner(s), so the fire extinguishing foam will not automatically or prematurely be deployed. If desired, there can also be tubes directed and secured over the grilling surface to better distribute the fire extinguishing foam or composition.

### BRIEF DESCRIPTION OF THE DRAWINGS

FIG. 1 is a perspective view of a barbecue with the fire suppression device.

FIG. 2 is a perspective view of the cannister of fire extinguishing foam with the distribution tubes.

FIG. 3 is an enlarged perspective view of the outlets of the distribution tube.

FIG. 4 is an enlarged view showing an alternate embodiment where the distribution tube has two branches.

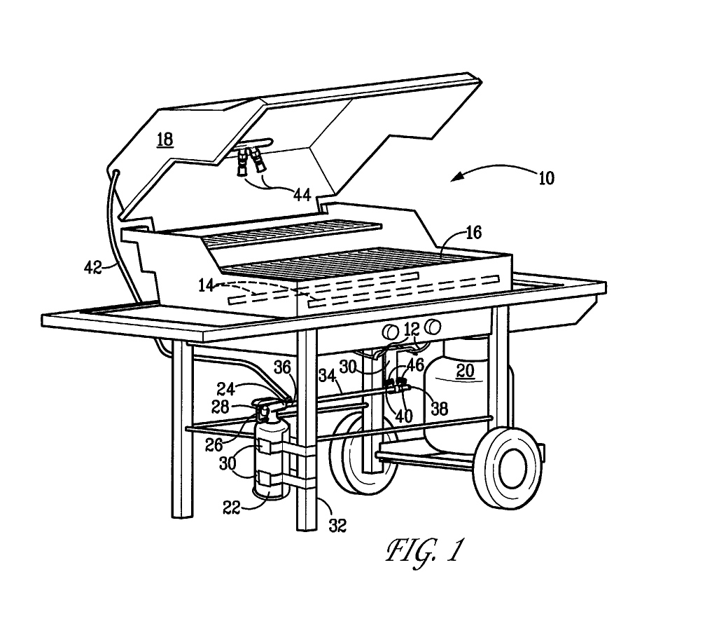

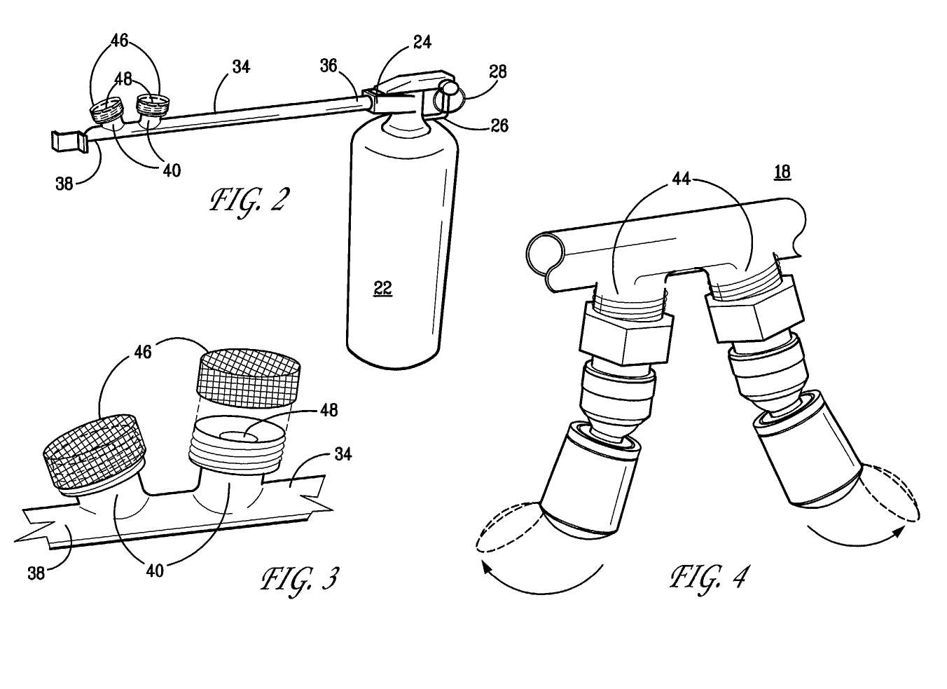

### DETAILED DESCRIPTION OF THE INVENTION

As shown, the invention is utilized in a standard gas barbecue 10. The barbecue includes a flat bottom with ventilation openings and openings for Venturi tubes 12, as is known in the industry. There are vertical sides, front and back and an open top to define an interior fire bowl. Within the fire bowl, the burners 14 are located. Above the burners, a grid is positioned for supporting charcoal briquettes, which may typically be of volcanic rock. A cooking grid 16 is place over the briquettes, and is usually secured in notches on the side walls. Secured to the back is a lid 18, usually by hinges, to cover the cooking area of the barbecue. Some barbecues are supported on a cental pedestal with a supporting base. Other barbecues have vertical legs to define a cart-like frame with wheels. The propane tank 20 either sits next to the barbecue or, preferably, it rests on the base of the barbecue. The barbecue itself is in all aspects well known in the industry.

A fire extinguishing composition or foam is stored within a cannister 22. The canister is a standard vertical or horizontal cylinder container with a nozzle 24 at the mouth of the canister for emitting the fire extinguishing composition or foam. Some canisters may have a handle 26 to facilitate positioning. A pull ring 28 or trigger or other conventional device is positioned at the top of the canister to start the flow of the fire extinguishing composition or foam from the nozzle 24. Depending on the design of the canister, it may be necessary to squeeze the trigger on the nozzle after the pull-ring is pulled.

Any know means may be used for securing the canister to the barbecue. Generally, it should be on the side opposite the propane tank. In the preferred embodiment, a specially designed bracket 30 is used to secure the canister away and below from the grill area. Sometimes, metal straps with buckles, of the type customarily used to secure fire extinguishers on walls and other support surfaces, may be used and such a strap can be used to secure the canister 22 to the pedestal or a vertical leg 32 of the barbecue. It is also possible to suspend a hook from the bottom of the barbecue and support the canister on the hook.

As fire extinguishers should typically not be exposed to temperatures above 120° F., it is preferable to keep the canister of the fire extinguishing composition or foam reasonably below and away from the body of the barbecue. Necessarily, the cannister must be mounted at a distance and position from the potential sources of fire, in order to avoid exposing the canister to temperatures exceeding 120° F.

A distribution tube 34 has one end 36 secured to the nozzle 24. The tube is a viable hollow metal tube. On some barbecues, there may be a need to have brackets to better support the tube. The end 36 of the tube 34 may be threaded and be screwed into a similar threaded opening in the nozzle 24. In some embodiments, the end 36 may have no thread and it may just be pushed into the nozzle and held by a frictional fit.

The distribution tube 34 has one or more outlets 40 at its other end 38 or along its length. Depending on the barbecue, the outlets may just be in the vicinity of the Venturi tubes 12, or they may also be above the cooking grid 16. Since barbecues come in many different sizes with any number of Venturi tubes and burners, almost any number of outlets may be necessary on the distribution tube. The particular number will depend on the particular barbecue in connection with which it is to be used. For larger grills, extension tubes may be needed to augment the length of the distribution tubes.

On the embodiment shown in the drawings, the distribution tube is straight and terminates with two outlets, directed at the Venturi tubes. If a fire spreads out from the Venturi tubes, the pull-ring on the canister can be pulled, which will cause the fire extinguishing composition or foam to pass through the distribution tube and out from the outlets, thereby quickly and efficiently putting out the fire. On some canister models, after the pull-ring is pulled, the trigger on the canister must still be squeezed to activate the flow of the fire extinguishing composition.

In addition, another branch 42 of the distribution tube can extend up along the side of the barbecue and be bent to enter through the lid 18, so that these outlets 44 face downward toward the cooking grid 16 and the burners 14. Preferably a separate flexible hose is used. When necessary, it may be secured to the side of the grill. A “Y” connection can be used to connect the two branches of the distribution tube. If a fire starts on the surface, the fire extinguishing composition or foam can be directed to the fires from the outlets 44 in the lid 18 of the barbecue. In particular, the “Y” connection extends out from the canister. The distribution tube 34 has one end 36 connected to the “Y” connection and the other end runs under the barbecue below the Venturi tubes. A bracket may be used to hold this tube. The length of the tube will depend on the size of the barbecue. If necessary, extension tubes may be used, especially for larger barbecue grills.

The bracket 30 can also hang down from the bottom of the barbecue. This permits the distribution tube to be snapped into position and there is a friction fit, so the tube is not moved. At the end of the distribution tube (below the Venturi tubes) there are round openings that are pointed away from each other. In this manner the fire extinguishing composition can be distributed to the entire area of the Venturi tubes. Mesh screen 46 are placed over the openings 48 to prevent blockage and to permit a flow of the fire extinguishing composition to the source of the fire. In addition, the mesh prevents debris and food particles from clogging the openings.

For safety reasons an upper portion of the branch 42 may be covered with a hose or a hose may be used instead of the tubing. Preferably, the hoses should be flexible and heat resistant.

If desired, the outlet nozzles may be swivel mounted, so they can be better aimed at any fire. Other embodiments may have break away caps on the nozzles to prevent blockage and clogging of the openings.

In the undersurface of the lid, the same type of outlet nozzles are used to distribute the fire extinguishing composition, as are used to direct the flow at the Venturi tubes. If the grill is sufficiently large, larger heads may be attached.

The invention is described in detail with reference to a particular embodiment, but it should be understood that various other modifications can be effected and still be within the spirit and scope of the invention.

I claim:

1. A safety-device for a gas fired barbecue to extinguish dangerous fires that emanate from the Venturi tubes and/or the burners and/or the cooking surface of said barbecue, comprising a cannister containing a fire extinguishing composition and which is positioned on said barbecue, wherein said cannister having a distribution tube with openings directed toward said Venturi tubes and/or said burners for directed said fire extinguishing composition onto a fire, and wherein said cannister further includes an activation control for initiating the flow of the fire extinguishing composition.

2. A device according to claim 1, wherein the activation control is a pull-ring.

3. A device according to claim 1, wherein the activation control is a trigger.

4. A device according to claim 1, wherein a nozzle is fitted over a mouth of said canister and said distribution tube is fitted into said nozzle.

5. A device according to claim 1, wherein said distribution tube has a first branch with outlets facing said Venturi tubes and a second branch with outlets extending down from a lid of said barbecue and towards said burners.

6. A device according to claim 5, wherein a Y joint connects said first and second branches of said distribution tube.
